(19) United States
(12) Patent Application Publication
(10) Pub. No.: US 2010/0086795 A1
(43) Pub. Date: Apr. 8, 2010

(54) RADIATION IMAGE CONVERSION PANEL

(75) Inventor: Yoko Hirai, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Medical & Graphic, Inc., Hino-shi (JP)

(21) Appl. No.: 12/449,910

(22) PCT Filed: Mar. 6, 2008
(86) PCT No.: PCT/JP2008/054041

§ 371 Date: Sep. 2, 2009

(30) Foreign Application Priority Data
Mar. 12, 2007 (JP) 2007-061635

(51) Int. Cl. B32B 27/36

(52) U.S. Cl. 428/480

(57) ABSTRACT

Disclosed is radiation image conversion panel exhibiting excellent luminance moisture resistance (excellent durability during storage specifically at high temperature and high humidity).

### TECHNICAL FIELD

The present invention relates to a radiation image conversion panel, and to a radiation image conversion panel for medical treatment and high image quality diagnosis, provided with a stimulable phosphor layer prepared via a vapor deposition method, which exhibits excellent luminance moisture resistance (specifically, excellent durability during storage at high temperature and high humidity).

### BACKGROUND

The radiation image conversion panel provided with a stimulable phosphor layer prepared via a vapor deposition method is utilized to obtain high quality diagnosis images for the medical treatment. However, since these panels have a feature exhibiting a drawback of weakness against humidity, a plate is desired to be coated with a sealing film to protect the phosphor, as disclosed in Japanese Patent O.P.I. Publication No. 2005-257287.

Thus, in order to improve the plate performance, various kinds of techniques have been investigated. For example, as disclosed in Japanese Patent O.P.I. Publication No. 2006-138642, known is a method to improve adhesiveness and impact resistance by providing an organic undercoat layer onto an aluminum substrate. Further, techniques to improve properties such as impact resistance and moisture resistance by providing a fluorine based resin, a silicon based resin or polyparaxylene(parylene) are disclosed in Patent Documents 1, 2 and 3, for example.

These techniques can be utilized in combination with several methods, but there appears a problem such that specifically, durability during storage at high temperature and high humidity (luminance moisture humidity), is largely degraded, resulting in unbearable feasibility.

Patent Document 1: Japanese Patent O.P.I. Publication No. 2-193100

Patent Document 2: Japanese Patent O.P.I. Publication No. 2001-228299

Patent Document 3: Japanese Patent O.P.I. Publication No. 2004-251879

### DISCLOSURE OF THE INVENTION

### Problems to be Solved by the Invention

It is an object of the present invention to provide a radiation image conversion panel exhibiting excellent luminance moisture resistance (specifically, excellent durability during storage at high temperature and high humidity).

### Means to Solve the Problems

The above-described object of the present invention has been accomplished by the following structures.

(Structure 1) A radiation image conversion panel comprising a phosphor plate and a gas barrier protective film entirely covering the phosphor plate, the phosphor plate comprising a substrate and provided thereon, a stimulable phosphor layer formed via a vapor deposition method, wherein a polymer layer is provided on at least one of the substrate and the stimulable phosphor layer, the polymer layer has a low molecular component amount of 0.00001-500 mg/m², and the protective film has a water vapor permeability of 0.0001-1.0 g/m²·24 h.

(Structure 2) The radiation image conversion panel of Structure 1, wherein the substrate comprises an organic polymer, a total amount of a 1^{st} low molecular component contained in the substrate and a 2^{nd} low molecular component contained in the polymer layer is 0.00001-500 mg/m², and the protective film has a water vapor permeability of 0.0001-1.0 g/m²·24 h.

(Structure 3) A radiation image conversion panel comprising a phosphor plate and a gas barrier protective film entirely covering the phosphor plate, the phosphor plate comprising a substrate and provided thereon, a stimulable phosphor layer formed via a vapor deposition method, wherein the substrate comprises an organic polymer, the substrate has a low molecular component amount of 0.00001-500 mg/m², and the protective film has a water vapor permeability of 0.0001-1.0 g/m²·24 h.

### Effect of the Invention

A radiation image conversion panel exhibiting excellent luminance moisture resistance (specifically, excellent durability during storage at high temperature and high humidity) can be provided by the present invention.

### BRIEF DESCRIPTION OF THE DRAWINGS

FIG. 1 is a schematic diagram showing an example of a vapor deposition (evaporation) apparatus employed for preparation of the radiation image conversion panel of the present invention.

### EXPLANATION OF NUMERALS

1 Evaporation apparatus
2 Vacuum chamber
3 Evaporation source
4 Support holder
5 Support rotation mechanism
6 Vacuum pump
7 Shutter
11 Support

### DESCRIPTION OF THE PREFERRED EMBODIMENTS

As to a radiation image conversion panel of the present invention, the radiation image conversion panel exhibiting excellent luminance moisture resistance (specifically, excellent durability during storage at high temperature and high humidity) can be provided via application of the constitution described in any one of Structures 1-3.

Next, each constituting element of the present invention will be successively described in detail.

The inventor has found out that through analysis of the cause of the phenomenon, the degradation in durability is caused by the organic low molecular component, that is, since diffusion of the low molecular component is inhibited in combination with a protective film exhibiting a high barrier property, and the interaction with a phosphor layer is enhanced, degradation in luminance moisture humidity is to be accelerated, and the inventor has accomplished the present invention.

As described in Structure 1, it is a feature that disclosed is a radiation image conversion panel possessing a phosphor plate and a gas barrier protective film entirely covering the phosphor plate, the phosphor plate possessing a substrate and provided thereon, a stimulable phosphor layer formed via a vapor deposition method, wherein a polymer layer is provided on at least one of the substrate and the stimulable phosphor layer; the polymer layer has a low molecular component amount of 0.00001-500 mg/m²; and the protective film has a water vapor permeability of 0.0001-1.0 g/m²·24 h.

In addition, the water vapor permeability of the protective film provided in a radiation image conversion panel of the present invention is measured in accordance with a method specified by JIS K 7129B (a temperature of 40° C. and a humidity of 90%).

As described above, the polymer layer provided on at least one of the substrate and the stimulable phosphor layer has a low molecular component amount of 0.00001-500 mg/m², preferably has a low molecular component amount of 0.0001-20 mg/m², and more preferably has a low molecular component amount of 0.0005-10 mg/m².

The foregoing low molecular component amount of at least 0.00001 mg/m² is preferable in view of maintaining of adhesion to an adjacent layer, impact resistance and so forth, and the low molecular component amount of 500 mg/m² or less is effective in view of inhibition of deterioration of the phosphor caused by transition of the low molecular component.

Further, the protective film has a water vapor permeability of 0.00001-1.0 g/m²·24 h, preferably has a water vapor permeability of 0.0001-0.2 g/m²·24 h, and more preferably has a water vapor permeability of 0.0001-0.1 g/m²·24 h.

The foregoing protective film having a water vapor permeability of at least 0.0001 g/m²·24 h is preferable in view of the produced effect to exhaust low molecular component vapor generated in a small amount into the outside of the system, and the foregoing protective film having a water vapor permeability of 1.0 g/m²·24 h or less is preferable in view of inhibition of deterioration of the phosphor against the panel use environment and humidity.

In the case of the radiation image conversion panel of Structure 2, it is a feature that disclosed is the radiation image conversion panel of Structure 1, wherein the substrate possesses an organic polymer, a total amount of a 1^{st} low molecular component contained in the substrate and a 2^{nd} low molecular component contained in the polymer layer is 0.001-500 mg/m², and the protective film has a water vapor permeability of 0.0001-1.0 g/m²·24 h.

The total amount of the low molecular component contained in the organic polymer of the foregoing substrate and the low molecular component contained in the foregoing polymer layer is preferably 0.00001-500 mg/m², more preferably 0.0001-20 mg/m², and still more preferably 0.0005-10 mg/m². The low molecular component of at least 0.00001 mg/m² is preferable since formed layer adhesion, impact resistance of the film, flexibility and so forth are maintained, and heat resistance during evaporation becomes practically available.

On the other hand, the low molecular component of 500 mg/m² or less is preferable in view of inhibition of property degradation caused by the low molecular component in combination with the protective film.

Further, the protective film has a water vapor permeability of 0.00001-1.0 g/m²·24 h, preferably has a water vapor permeability of 0.0001-0.2 g/m²·24 h, and more preferably has a water vapor permeability of 0.0001-0.1 g/m²·24 h. As described above, the protective film having a water vapor permeability of at least 0.0001 g/m²·24 h preferably produces the effect to exhaust low molecular component vapor generated in a small amount into the outside of the system. On the other hand, the protective film having a water vapor permeability of 1.0 g/m²·24 h or less can inhibit deterioration of the phosphor caused by humidity in the panel use environment and others such as harmful gas and so forth.

It is a feature described in Structure 3 that disclosed is a radiation image conversion panel comprising a phosphor plate and a gas barrier protective film entirely covering the phosphor plate, the phosphor plate comprising a substrate and provided thereon, a stimulable phosphor layer formed via a vapor deposition method, wherein the substrate comprises an organic polymer, the substrate has a low molecular component amount of 0.00001-500 mg/m², and the protective film has a water vapor permeability of 0.0001-1.0 g/m²·24 h.

The above-described organic polymer constituting the substrate has a low molecular component amount of 0.00001-500 mg/m², preferably has a low molecular component amount of 0.0001-20 mg/m², and more preferably has a low molecular component amount of 0.0005-10 mg/m².

The low molecular component amount of at least 0.00001 mg/m² is preferable since sufficient heating performance during evaporation becomes practically available, and the low molecular component amount of 500 mg/m² or less is preferable since property deterioration caused by the low molecular component is inhibited in combination with the protective film.

Further, the protective film has a water vapor permeability of 0.00001-1.0 g/m²·24 h, preferably has a water vapor permeability of 0.0001-0.2 g/m²·24 h, and more preferably has a water vapor permeability of 0.0001-0.1 g/m²·24 h. The foregoing protective film having a water vapor permeability of at least 0.0001 g/m²·24 h is preferable in view of the produced effect to exhaust low molecular component vapor generated in a small amount into the outside of the system, and the foregoing protective film having a water vapor permeability of 1.0 g/m²·24 h or less is preferable in view of moisture content in the use environment and improvement of barrier performance against gas to induce deterioration as others.

Next, the present invention will be described in detail.

### <<Substrate>>

Various polymer materials, glass, metal and so forth are utilized for the substrate provided in a radiation image conversion panel of the present invention, and preferable examples thereof include plate glass such as quartz, borosilicate glass, chemically tempered glass or the like; a polymer film; and a metal sheet made of aluminum, iron, copper, chromium or the like, and a metal sheet having a coating layer composed of hydrophilic particles. The he substrate may have the smooth surface or may be matte for the purpose of improving adheasion to a stimulable phosphor layer. Further in the present invention, an adhesion layer may be formed on the surface of a substrate support, if desired, in order to improve adhesion between the substrate and the stimulable phosphor layer.

Though the thickness of these supports depends on material quality used for the support, it is generally 80-2000 μm, and preferably 80-1000 μm in view of handling.

The polymer film used for the substrate is not specifically limited, and usable examples thereof include polyethylene terephthalate, polyethylene naphthalate, cellulose acetate, polyamide, polyimide, epoxy, polyamideimide, bismaleimide, a fluorine resin, acryl, polyurethane, nylon 12, nylon 6, polycarbonate, polyphenylenesulfide, polyethersulfone, polysulfone, polyetherimide, polyether ether ketone and so forth, but when a phosphor is formed via vapor deposition, it is preferred that a glass transition temperature of the support is not 100° C. or less so as not to deform the support via heat.

As the polymer film employed for the substrate of the present invention, polyimide, polyethylene naphthalate, polyethersulfone and polysulfone are preferable in view of heat resistance, but polyimide is more preferable.

The effect of the present invention is preferably produced by employing the foregoing substrate including the polymer film on which metal is coated.

A technique concerning a plate having an amorphous carbon substrate coated with an aluminum layer is disclosed in Japanese Patent O.P.I. Publication No. 2004-251883, but when a polymer film, unlike inflexible amorphous carbon, is coated with metal, the continuous processing in the form of a roll becomes possible, whereby productivity can be largely improved.

The method in which a polymer film coated with metal is not specifically limited, but examples thereof include an evaporation method, a sputtering method, a metal foil lamination method or such. Of these, a sputtering method is preferable in view of adhesion to a polymer film.

In the present invention, a metal-coated polymer film preferably has a surface reflectance of at least 80%, and more preferably has a surface reflectance of at least 90%. When a support has a surface reflectance of at least 90%, luminance is largely improved since emission of a phosphor can be efficiently taken out. Kinds of the coated metal are not specifically limited, and examples thereof include aluminum, silver, platinum, gold, copper, iron, nickel, chromium, cobalt and so forth. Though no limitation is specifically given, aluminum is most preferable in view of reflectance and corrosion.

In the present invention, the low molecular compound contained in the organic substrate of the present invention means a low molecular compound having a molecular weight of 1000 or less, and examples thereof include a residual monomer and an initiator decomposing material which have not been employed for polymerization and crosslinkage, and an activator, a plasticizer, and various kinds of solvents and a low molecular dye which are employed to adjust matter properties. Of these low molecular compounds, specifically considerable low molecular compounds are those having a molecular weight of 500 or less, and when these remain largely, influence to phosphor deterioration (degradation in luminance moisture resistance of a phosphor layer) becomes large.

The low molecular compound preferably has a content of 0.00001-10 mg/m². The content of at least 0.00001 mg/m² can adjust matter properties of an organic matter layer, inhibit easy generation of cracks or the like, and inhibit deterioration in moisture resistance after having an impact. Further, the content of 10 mg/m² or less preferably reduces deterioration in moisture resistance.

In order to obtain the organic matter layer of the present invention, not only the low material component of raw material is reduced, but also the low molecular component is removed by a commonly known method such as vacuum aging, heat-application storage or the like.

### (Method of Measuring Low Molecular Component)

As the method of measuring a low molecular component, an evaluation sample is prepared in thickness employed for a phosphor panel, and the sample can be analyzed employing GC/MS (Gas chromatograph—Mass spectrometer) to measure the low molecular component. In cases where plural kinds of low molecular components are present, the total content is utilized.

### <<Polymer Layer>>

The polymer layer of the present invention will be described.

The polymer layer of the present invention can be provided on a substrate or a phosphor layer.

In order to form a polymer layer of the present invention, usable are, for example, a polyamide based resin, a polyester based resin, an epoxy based resin, a polyurethane based resin, a polyacrylic resin (for example, polymethyl methacrylate, polyacrylamide or polystyrene-2-acrylonitril), a vinyl based resin such as polyvinylpyrrolidone or the like, a polyvinyl chloride based resin (for example, a vinyl chloride-vinyl acetate copolymer), a polycarbonate based resin, polystyrene, polyphenylene oxide, a cellulose based resin (for example, methyl cellulose, ethyl cellulose, carboxymethyl cellulose, cellulose acetate hydrogen phthalate, cellulose acetate, cellulose acetate propionate, cellulose acetate butylate and cellulose triacetate), a polyvinyl alcohol based resin (for example, partially saponified polyvinyl alcohol such as polyvinyl alcohol, polyvinyl acetal, polyvinyl butyral or the like), a petroleum based resin, a rosin derivative, a coumarone-indene resin, a terpene based resin, a polyolefin based resin (for example, polyethylene and polypropylene) and so forth.

Further, a polymer obtained via polymerization reaction of the following polymerizable monomers (referred to also as polymerizable compounds) with heat, light, electron beams or the like can be utilized for the polymer layer of the present invention.

### (Polymerizable Monomer)

Examples of the polymerizable monomer employed in the present invention include a hydrophobic monomer, a crosslinkable monomer, a monomer having an acidic polar group, a monomer having a basic polar group and so forth.

These monomers may singly form a polymer, and a copolymer may be formed by using a plurality of monomers and be contained in a polymer layer.

### (1) Hydrophobic Monomer

The hydrophobic monomer constituting a monomer component is not specifically limited, and commonly known monomers are usable. They can be used singly or in combination with at least two kinds so as to satisfy desired properties.

Specifically usable are an aromatic monovinyl based monomer, a (meth)acrylic acid ester based monomer, a vinyl ether based monomer, a monoolefin based monomer, a diolefin based monomer, a halogenated olefin based monomer and so forth.

Examples of the aromatic vinyl based monomer include styrene based monomers such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrne, p-n-nonylstyrene, p-n-decylstyrene, p-n-dodecyistyrene, 2,4-dimethylstyrne and 3,4-dichlorostyrene; and derivatives thereof.

Examples of the (meth)acrylic acid ester based monomer include an acrylic acid, a methacrylic acid, methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxy acrylate, propyl γ-amino acrylate, stearyl methacrylate, dimethylaminoethyl methacrylate, diethylaminoethyl methacrylate and so forth.

Examples of the vinyl ester based monomer include vinyl acetate, vinyl propionate, vinyl benzoate and so forth, and examples of the vinyl ether based monomer include vinylmethyl ether, vinylethyl ether, vinylisobutyl ether, vinylphenyl ether and so forth.

Examples of the monoolefin based monomer include ethylene, propylene, isobutylene, 1-butene, 1-pentene, 4-methyl-1-pentene and so forth, and examples of the diolefin based monomer include butadiene, isoprene, chloroprene and so forth.

### (2) Crosslinkable Monomer

A crosslinkable monomer may be added in order to improve properties of resin particles. Examples of the crosslinkable monomer include those having at least two unsaturated bonds such as divinyl benzene, divinyl naphthalene, divinyl ether, diethylene glycol methacrylate, ethylene glycol dimethacrylate, polyethylene glycol dimethacrylate, diallyl phthalate and so forth.

### (3) Monomer Having Acidic Polar Group

As the acidic polar group, listed can be (a) α,β-ethylenic unsaturated compound having a carboxyl group (—COOH) and (b) α,β-ethylenic unsaturated compound having a sulfo group (—SO₃H).

Examples of (a) α,β-ethylenic unsaturated compound having a carboxyl group include an acrylic acid, a methacrylic acid, a fumaric acid, a maleic acid, an itaconic acid, a cennamic acid, monobutyl ester maleate, monooctyl ester maleate, and their metal salts of Na, Zn or the like.

Examples of (b) α,β-ethylenic unsaturated compound having a sulfo group include sulfonated styrene and its Na salt, and an allylsulfosuccinic acid octyl allylsulfosuccinate and their Na salts.

### (4) Monomer Having Basic Polar Group

As the monomer having a basic polar group, listed can be (a) methacrylic acid ester of aliphatic alcohol having an amine group or a quaternary ammonium group, possessing 1-12 carbon atoms, preferably 2-8 carbon atoms and more preferably 2 carbon atoms; (b) amide methacrylate, or amide methacrylate optionally mono- or di-substituted on N by an alkyl group possessing 1-18 carbon atoms; (c) a vinyl compound substituted by a heterocyclic group having N as a ring member; and (d) N,N-diallyl-alkylamine or a quaternary ammonium salt thereof. Of these, (a) methacrylic acid ester of aliphatic alcohol having an amine group or a quaternary ammonium group is preferred as a monomer having a basic polar group.

Examples of (a) methacrylic acid ester of aliphatic alcohol having an amine group or a quaternary ammonium group include dimethylaminoethylacrylate, dimethylaminoethylmethacrylate, diethylaminoethylacrylate, diethylaminoethylmethacrylate, quaternary ammonium salts of the above-described four compounds, 3-dimethylaminophenylacrylate, 2-hydroxy-3-methacryloxypropyl trimethylammonium salt, and so forth.

Examples of (b) amide methacrylate, or amide methacrylate optionally mono- or di-substituted on N by the alkyl group include acrylamide, N-butylacrylamide, N,N-dibutylacrylamide, piperidylacrylamide, methacrylamide, N-butylmethacrylamide, N,N-dimethylacrylamide, N-octadecylacrylamide and so forth.

Examples of (c) a vinyl compound substituted by a heterocyclic group having N as a ring member include vinylpyridine, vinylpyrrolidone, vinyl-N-methylpyridinium chloride, vinyl-N-ethylpyridinium chloride and so forth.

Examples of (d) N,N-diallyl-alkylamine include N,N-di-allyl-methylammonium chloride, N,N-diallyl-ethylammonium chloride and so forth.

{Low Molecular Component (Referred to also as Low Molecular Compound) Contained in Polymer Layer}

In the present invention, the low molecular compound contained in a polymer layer means a low molecular compound having a molecular weight of 1000 or less, and examples thereof include a residual monomer and an initiator decomposing material which have not been employed for polymerization and crosslinkage, and an activator, a plasticizer, and various kinds of solvents and a low molecular dye which are employed to adjust matter properties. Of these low molecular compounds, specifically considerable low molecular compounds are those having a molecular weight of 500 or less, and when these remain largely, influence to phosphor deterioration (degradation in luminance moisture resistance of a phosphor layer) becomes large.

The low molecular compound preferably has a content of 0.00001-10 mg/m². The content of at least 0.00001 mg/m² can adjust matter properties of a polymer layer, inhibit easy generation of cracks or the like, and inhibit deterioration in moisture resistance after having an impact. Further, the content of 10 mg/m² or less preferably reduces deterioration in moisture resistance.

In order to obtain the polymer layer of the present invention, not only the low material component of raw material is reduced, but also the low molecular component is removed by a commonly known method such as vacuum aging, heat-application storage or the like.

### (Method of Measuring Low Molecular Component)

As the method of measuring a low molecular component, an evaluation sample is prepared in thickness employed for a phosphor panel, and the sample can be analyzed employing GC/MS (Gas chromatograph—Mass spectrometer) to measure the low molecular component. In cases where plural kinds of low molecular components are present, the total content is utilized.

### (Protective Layer on Upper Surface of Phosphor Layer)

A protective layer may be provided on the upper surface of a phosphor layer of the present invention, and one exhibiting excellent transparency, which can be formed in the form of a sheet, is usable. Examples thereof include plate glass such as quartz, borosilicate glass, chemically tempered glass or the like, and organic polymers such as PET, OPP, polyvinyl chloride and so forth.

The protective layer may be a single layer, be a multilayer, and be one composed of at least two layers each made of a different material. For example, usable is a film combined with a polymer film composed of at least two layers. Examples of methods of preparing such the composite polymer film include an evaporation lamination method, a dry lamination method, a co-extrusion lamination method and so forth. As a combination with at least two protective layers, it is not limited to organic polymer-to-organic polymer, and plate glass-to-plate glass, plate glass-to-organic polymer and so forth are provided. As a method to combine the plate glass with the polymer layer, there are one formed by directly coating a protective layer coating solution onto the plate glass, and a method of attaching a polymer protective layer separately formed in advance onto the plate glass. In addition, at least two protective layers may be brought into contact with each other, and may be separate from each other.

The protective layer of the present invention has a practical thickness of 10 μm-3 mm. The protective layer having a thickness of at least 100 μm is preferable in order to obtain excellent moisture resistance and impact resistance. Specifically, the protective layer having a thickness of at least 500 μm is more preferable since radiation image conversion panels each exhibiting excellent durability and excellent service life are obtained.

Further, when the plate glass is employed as a protective layer, since the plate glass exhibiting highly excellent moisture resistance, it is specifically preferable.

The protective layer is preferably desired to exhibit high transmittance in the wide wavelength range in order to effectively transmit stimulated emission light as well as stimulated luminescence, and a transmittance of at least 80% is preferable. Preferable examples thereof include quartz, borosilicate glass and so forth. Borosilicate glass exhibits a transmittance of at least 80% in the wavelength range of 330 nm-2.6 μm, and quartz also exhibits high transmittance in the shorter wavelength range.

Further, formation of an antireflection layer made of MgF₂ on the surface of the protective layer is preferable since there appears the effect of producing effective transmission of stimulated emission light as well as stimulated luminescence together with reduction of lowering of sharpness. The refractive index of the protective layer is not particularly limited, but practically usable materials usually exhibit a refractive index of 1.4-2.0.

In the present invention, a plate glass is preferred as a material constituting the protective layer. There are the following methods for the means to have a function of absorbing stimulated emission light via coloration made by containing an colorant in glass.

(1) The film colored with a colorant (a pigment or a dye) is layered on the glass.

As a method of manufacturing a colored film, there is a method of forming a layer containing the colorant (a pigment or a dye) in the surface of a plastic film or a plastic film in which a colorant has been kneaded.

The colored glass can be acquired as a protective layer via a step of evenly attaching the colored plastic film prepared by such the method, employing an adhesive or the like.

A pigment or a dye to absorb stimulated emission light is suitable as a colorant usable for coloring for the objective.

(2) A method of forming a layer containing a dye or a pigment in either one surface or the other surface via coating.

This method is a method of acquiring colored glass by coating a pigment or a dye dispersed or dissolved in a binder exhibiting good adhesiveness directly to glass (liquid glass, polyvinyl butyral or the like).

Next, (3) A method to contain a pigment dispersed as a colorant, or a colorant in glass itself.

For example, coloring is made by mixing a colorant such as lead phosphate or the like in glass during preparation. In this case, a colorant exhibiting good thermal stability is demanded because of the mixing during preparation of the glass, and inorganic pigments exhibiting heat resistance among pigments can be used via dispersion.

### (Parylene Evaporation)

In the present invention, the most preferable polymer is evaporated in order to be employed as an organic substance layer (a protective layer provided on a phosphor layer of the present invention) on the surface of the phosphor layer in the present invention, and preferable is a poly-p-xylene film prepared via chemical vapor deposition.

Poly-p-xylene possesses repeating units in the range of 10-10000, and each repeating unit possesses a substituted or unsubstituted aromatic nucleus group. Preferable is a commercially available di-p-xylene composition sold by Union Carbide Co. (trademark “PARYLENE” as a base reagent).

The preferable compositions for the organic layer of the present invention provided on the surface of the phosphor layer unsubstituted “PARYLENE N”, monochiorine-substituted “PARYLENE C”, dichlorine-substituted “PARYLENE D”, and “PARYLENE HT” (A perfectly fluorine-substituted type of “PARYLENE N” exhibiting UV resistance and heat resistance up to 400° C. in comparison to other “PARYLENEs”; but having almost the same heat resistance as that of “PARYLENE C”).

The most preferable polymer to be used for preparation of the organic substance layer of the present invention provided on the surface of the phosphor layer in a radiation image conversion panel of the present invention is poly(p-2-chloroxylene), that is, a PARYLENE C film, poly(p-2,6-dichloroxylene), that is, a PARYLENE D film, and “PARYLENE HT” (A perfectly fluorine-substituted type of PARYLENE N).

The parylene layer as a moisture barrier layer provided in a radiation image conversion panel of the present invention or a screen has an advantage of heat resistance, and the heat resistance of the parylene layer means one endurable to the temperature desired for evaporation of a stored phosphor thereof. Application of the parylene layer provided in the stored phosphor screen has been disclosed in European Patent Open to Public Inspection Publication No. 1286363; European Patent Open to Public Inspection Publication No. 1286364; European Patent Open to Public Inspection Publication No. 1286362; and European Patent Open to Public Inspection Publication No. 1286365.

### {Organic Substance Layer on the Undersurface of Phosphor Layer (Undercoat Layer)}

The organic substance layer on the undersurface of a phosphor layer of the present invention (hereinafter, referred to also as an undercoat layer of the present invention) preferably contains a polymer resin to be crosslinkable with a crosslinking agent and its crosslinking agent.

Any polymer resin can be used for the undercoat layer. Examples thereof include polyurethane, polyester, vinyl chloride copolymer, vinyl chloride-vinyl acetate copolymer, vinyl chloride-vinylidene chloride copolymer, vinyl chloride acrylonitrile copolymer, butadiene-acrylonitrile copolymer, polyamide resin, polyvinyl butyral, cellulose derivative (such as nitrocellulose), styrene-butadiene copolymer, a variety of synthetic rubber resins, phenol resin, epoxy resin, urea resin, melamine resin, phenoxy resin, silicone resin, acrylic resin, urea formamide resin and so on.

Of these, polyurethane, polyester, vinyl chloride copolymer, polyvinyl butyral, and nitro-cellulose are preferable. Further, the mean glass transition temperature (Tg) of polymer resin used for the undercoat layer should be at least 25° C. and more preferably 25-200° C.

The crosslinking agent usable for the undercoat layer of the present invention is not specifically limited, and preferable examples thereof include multifunctional isocyanates and derivatives thereof, melamines and derivatives thereof, and amino resins and derivatives thereof, but multifunctional isocyanate compounds are preferably used as crosslinking agents. For example, listed are CORONATE HX and CORONATE 3041 (produced by Nippon Polyurethane Industry Co., Ltd.).

The undercoat layer of the present invention can be formed on a substrate via the following method, for example.

First, in this method an undercoat layer coating solution is prepared by adding the above-described polymer resin and crosslinking agent into an adequate solvent, for example, a solvent employed for preparation of the after-mentioned stimulable phosphor layer coating liquid, and by fully mixing the resulting.

The quantity of the crosslinking agent to be used is depends on characteristics of the intended radiation image conversion panel, raw materials for stimulable phosphor layers and the supports, and polymer resins for the undercoat layers. To assure adhesion of the stimulable phosphor layer to the support, weight of the crosslinking agent should be 50% by weight, and preferably 15-50% by weight, based on the polymer resin.

The thickness of the undercoat layer depends on characteristics of the intended radiation image conversion panel, raw materials used for stimulable phosphor layers and supports, and kinds of polymer resins and crosslinking agents used for the undercoat layers. Generally, the thickness should preferably be 0.05-50 μm, and more preferably 0.05-5 μm.

### <<Protective Film>>

The protective film of the present invention will be described.

The protective film of the present invention is a protective film exhibiting a gas barrier property, and can be a commonly known protective film. The protective film is possible to have a structure possessing a stimulated emission light absorbing layer, a matte layer, a sealant layer and so forth other than a barrier layer, and a plurality of these layers can be layered.

Further, the protective film of the present invention measured by the method in accordance with JIS K7129B (40° C. and 90% RH) is required to have a water vapor permeability of 0.0001-1.0 g/m²·24 h. In this case, an organic substance layer provided on the inward side from a barrier layer measures the residual low molecular component of the present invention, falling within the range of the present invention.

### (Barrier Layer Employed as Protective Film)

An evaporation layer, that is, a transparent evaporated film layer used as a barrier layer which is the protective film of the present invention serves as a gas barrier layer against water vapor, oxygen or the like, and is not specifically limited, since the level of this gas barrier depending on the application should be appropriately arranged to be set. In order to assure stable barrier performance and to minimize secondary environmental pollution caused by disposal, preferred are metals such as Al, Si, Ti, Zn, Zr, Mg, Sn, Cu, and Fe, and oxides and nitrides of these metals, and specifically preferred are SiOₓ (X=1.0-2.0), alumina, magnesia, zinc sulfide, titania, zirconia, cerium oxide and so forth. By using those, a mixed evaporation layer made of at least two kinds, if desired, can be prepared, or an evaporation layer having a multilayer structure is also possible to be prepared.

Generally, the above-described inorganic material evaporation layer preferably has a thickness of 1-500 nm, and more preferably has a thickness of 5-200 nm.

It is preferable to adjust the thickness in the above-described range in view of sufficient gas barrier provided to the inorganic material evaporation layer, flex resistance and manufacturing cost.

The above inorganic material evaporation layer is formed employing an appropriate method selected from a physical evaporation method such as a vacuum evaporation method, a sputtering method or an ion plating method, and a chemical vapor deposition method.

When a vacuum evaporation method is employed, employed as preferred evaporation materials are metals such as aluminum, silicon, titanium, magnesium, zirconium, cerium, or zinc, as well as compounds such as SiOₓ (x=1.0-2.0), alumina, magnesia, zinc sulfide, titania, or zirconia, or mixtures thereof. Employed as a heating method may be resistance heating, induction heating, electron beam heating and so forth.

Further introduced as a reaction gas may be oxygen, nitrogen, hydrogen, argon, carbon dioxide gas, water vapor or the like. Alternatively employed may be reactive evaporation simultaneously employing means such as ozone addition or ion assist.

Still further, varied may be film forming conditions such as application of bias to the substrate or heating and cooling of the substrate. When the sputtering method or the CVD method is employed, the above film forming conditions such as deposition materials, reaction gases, substrate bias, heating and cooling may be varied similarly to variation of the above-described film forming conditions.

In the present invention, various oxides, nitrides and so forth are provided for the inorganic compound layer as a principal layer to form the above-described gas barrier layer, but aluminum oxide or silicon oxide as a principal component is preferable in view of productivity and performance.

A sputtering method, a CVD method, an ion plating method and so forth, other than a vacuum evaporation method fitted with an evaporation means of resistance heating, induction heating or electron beam heating, are usable in order to form a gas barrier layer made of at least one of these aluminum oxide and silicon oxide, but preferable one is of a method of forming a film on a winding film via an evaporation method in view of productivity.

The layer made of at least one of such the aluminum oxide and silicon oxide preferably has a thickness of 5-100 nm, and preferably has a thickness of 10-50 nm, though the thickness slightly depends on the composition of this layer and so forth.

Not only a continuous layer can be formed, but also generation of cracks caused by internal stress can be effectively inhibited by adjusting the thickness within the above-described range.

It is effective, if desired, to provide an anchor coat on a transparent film substrate as its surface to form an evaporation layer, or prior to or during evaporation, to conduct a corona treatment, a flame treatment, a low temperature plasma treatment, a glow discharge treatment, a reverse sputtering treatment, or a surface roughening treatment to further enhance adhesion to the inorganic material evaporation layer.

### <<Stimulable Phosphor Layer>>

The stimulable phosphor layer of the present invention is an stimulable phosphor layer formed on a substrate via a vapor deposition method (referred to also as an evaporated phosphor layer).

Next, the evaporated phosphor layer will be described.

Examples of the stimulable phosphor usable for the evaporated phosphor layer include phosphors represented by BaSO₄:Aₓ disclosed in Japanese Patent O.P.I. Publication No. 48-80487, phosphors represented by SrSO₄:Aₓ disclosed in Japanese Patent O.P.I. Publication No. 48-80489, phosphors represented by Na₂SO₄, CaS and BaSO₄ each containing at least one of Dy and Dy disclosed in Japanese Patent O.P.I. Publication No. 51-29889, phosphor represented by BeO, LiF, MgSO₄ and CaF₂ disclosed in Japanese Patent O.P.I. Publication No. 52-30487, phosphors represented by Li₂B₄O₇:Cu,Ag disclosed in Japanese Patent O.P.I. Publication No. 53-39277, phosphors represented by Li₂O.(Be₂O₂)ₓ:Cu,Ag disclosed in Japanese Patent O.P.I. Publication No. 54-47883, phosphors represented by SrS:Ce,Sm, SrS:Eu,Sm, La₂O₂S:Eu,Sm and (Zn,Cd)S:Mnₓ disclosed in U.S. Pat. No. 3,859,527, and also phosphors represented by ZnS:Cu,Pb, barium aluminate phosphors represented by BaO.xAl₂O₃:Eu and alkaline earth metal silicate phosphors represented by M(II).xSiO₂:A disclosed in Japanese Patent Publication No. 55-12142.

There are further cited an alkaline earth fluorohalide phosphor represented by Formula (Ba_{1-x-y}MgₓCa_{y})Fₓ:Eu²⁺, as disclosed in Japanese Patent O.P.I. Publication No. 55-12143; phosphor represented by Formula: LnOX:xA, as disclosed in Japanese Patent O.P.I. Publication No. 55-12144; phosphor represented by Formula (Ba₁₋ₓM^{(II)}ₓ)Fₓ:yA, as disclosed in Japanese Patent O.P.I. Publication No. 55-12145; phosphor represented by Formula BaFX:xCe,yA, as disclosed in Japanese Patent O.P.I. Publication No. 55-84389; rare earth element-activated divalent metal fluorohalide phosphor represented by Formula M^{(II)}FX.xA:yLn, as disclosed in Japanese Patent O.P.I. Publication No. 55-160078; phosphor represented by Formula ZnS:A,CdS:A, (Zn,Cd)S:A,X; phosphor represented by Formulas xM₃(PO₄)₂.NX₂:yA and xM₃(PO₄)₂:yA, as disclosed in Japanese Patent O.P.I. Publication No. 59-38278; phosphor represented by Formulas nReX₃.mAX′₂:xEu and nReX₃.mAX′₂:xEu,ySm, as disclosed in Japanese Patent O.P.I. Publication No. 59-155487; alkali halide phosphor represented by Formula of M^{(I)X.aM}^{(II)}X′₂.bM^{(III)}X″₃:cA, as disclosed in Japanese Patent O.P.I. Publication No. 61-72087; and bismuth-activated alkali halide phosphor represented by Formula of M^{(II)}X:xBi, as disclosed in Japanese Patent O.P.I. Publication No. 61-228400.

Specifically preferred are alkali halide phosphors since they enable easy formation of a columnar stimulable phosphor layer employing an evaporation method, a sputtering method and so forth.

Further, as noted above, of the alkali halide phosphors, RbBr based phosphor and CsBr based phosphor are preferable in view of high luminance and high image quality, and of these, CsBr based phosphor is specifically preferable.

In a method of forming an evaporated phosphor layer on a substrate, vapor of a stimulable phosphor or raw material thereof is supplied onto the substrate at a specific angle toward the substrate, and a stimulable phosphor layer composed of long, thin columnar crystals formed independently can be obtained by a vapor-phase growth method (vapor deposition) such as evaporation or the like. Upon evaporation, the columnar crystals can be grown at a growing angle which is about half of the incident angle of the vapor stream of the stimulable phosphor. An evaporation film in the form of molecules can be formed via evaporation at about room temperature.

To supply the vapor stream of phosphor or raw material thereof at an incident angle to the substrate surface, the substrate and a crucible containing an evaporation source may be arranged to be placed so as to be inclined with each other. Alternatively, the substrate and the crucible which are arranged to be placed parallel to each other may be controlled so that only an inclined component from the evaporating surface of the crucible having an evaporation source deposits on the substrate using a slit.

In such a case, the shortest spacing between the support and the crucible is preferably 10-60 cm so as to fit the average flight of stimulable phosphor. In addition, the lower the temperature of the substrate, the thinner the columnar crystal tends to be.

The stimulable phosphor serving as a vaporizing source is placed in the crucible after being homogeneously dissolved or after being molded with a press or hot press. At this time, it is preferable to carry out degassing treatment. To vaporize the stimulable phosphor from the vaporizing source, a scanning method using electron beams, discharged from an electron gun, is employed, but deposition may be conducted via any other appropriate methods.

Further, the vaporizing source is not necessarily the stimulable phosphor, but a mixture with the stimulable phosphor raw material may be utilized.

Still further, an activator may be doped in a phosphor basic substance afterward. For example, after deposition of only RbBr serving as a basic substance, T1 serving as an activator may be doped for the following reasons: since crystals each are independent, doping may be adequately carried out even when the film thickness is large; and since the crystals tend not to grow, MTF may not decrease.

Doping is performed by allowing a doping agent (activator) to be introduced into a basic substance layer of a phosphor by means of thermal diffusion or ion injection.

As to the stimulable phosphor layer composed of these columnar crystals, in order to reduce a haze ratio, the columnar crystal diameter is preferably 1-50 μm, and more preferably 1-30 μm. The columnar crystal diameter refers to a mean value of diameters of circles equivalent to areas of the cross-section of each columnar crystal when viewed from the surface parallel to the substrate surface. The columnar crystal diameter is determined by measuring at least 100 columnar crystals in a viewing field employing an electron micrograph.

The spacing between respective columnar crystals is preferably 30 μm or less, and more preferably 5 μm or less. The spacing exceeding 30 μm lowers sharpness since scattering of laser light increases.

Nothing is specifically limited as long as the growing angle of inclined columnar crystals of the stimulable phosphor is at least 0° and not more than 90°, but the growing angle is preferably 10-70°, and more preferably 20-55°. A growing angle of 10-70° may be achieved by setting an incident angle of 20-80°, and a growing angle of 20-55° may be achieved by setting an incident angle of 40-70°. A greater growing angle results in a columnar crystal excessively inclined toward the substrate, as a result, forming a brittle film.

Examples of the method of vapor-phase-growing (depositing) the stimulable phosphor include an evaporation method, a sputtering method, and a CVD method.

As to an evaporation, after placing a substrate in an evaporator, the inside of the evaporator is evacuated to a vacuum degree of 1.333×10⁻⁴ Pa and subsequently, at least one stimulable phosphor is evaporated via heating with a resistance heating method or an electron-beam method to cause the stimulable phosphor to be deposited at a slant on the substrate surface to a desired thickness. As a result, a stimulable phosphor layer containing no binder is formed, provided that the foregoing evaporation stage may be divided into plural times to form the stimulable phosphor layer.

In this evaporation stage, plural resistance heaters or electron beams may be used to perform evaporation. Alternatively, stimulable phosphor raw material is evaporated using plural resistance heaters or electron beams and an intended stimulable phosphor is synthesized on the support, simultaneously forming a stimulable phosphor layer.

Evaporation may be conducted while cooling or heating the substrate to be deposited thereon. After completion of the evaporation, the stimulable phosphor layer may be subjected to a heat treatment.

As to sputtering method, after setting a substrate in a sputtering apparatus, the inside of the apparatus is evacuated to a vacuum level of 1.333×10⁻⁴ Pa and then inert gas used for sputtering such as Ar, Ne or the like is introduced thereto at a gas pressure of 1.333×10⁻¹ Pa, subsequently, sputtering is carried out in the inclined direction by using the stimulable phosphor as a target to cause the stimulable phosphor to be deposited at a slant on the substrate surface so as to have a desired thickness. Similarly to an evaporation method, the sputtering stage may be divided to plural steps to form a stimulable phosphor layer. Sputtering to the target may be carried out concurrently or successively to form a stimulable phosphor layer.

Further, using plural stimulable phosphor raw materials as a target, this is simultaneously or successively sputtered to form an intended stimulable phosphor layer on the substrate. Gas such as O₂, H₂ or the like may optionally be introduced, if desired, to perform reactive sputtering. Further, in a sputtering method, the evaporated substance may be cooled or heated during sputtering, if desired. After completion of sputtering, the stimulable phosphor layer may be subjected to a heat treatment.

The CVD method is a method in which an intended stimulable phosphor or an organometallic compound containing stimulable phosphor raw material is degraded by energy such as heat, high-frequency electric power or the like to form a stimulable phosphor layer containing no binder on the substrate. The stimulable phosphor layer is possible to be vapor-deposited in such a way that long, thin columnar crystals at a specific angle to the line normal to the surface of the substrate, which exist independently in isolation to each other, are obtained.

The thickness of the thus formed stimulable phosphor layer, depending on radiation sensitivity to radiation of an intended radiation image conversion panel and the kind of stimulable phosphor, is preferably 10-1000 μm, and more preferably 20-800 μm.

### Example

Next, the present invention will be described in detail referring to Examples, but the present invention is not limited thereto.

### Example 1

### <<Preparation of Radiation Image Conversion Panel 1>>

### (Preparation of Substrate 1 for Phosphor Plate)

In order to coat an undercoat layer (a dry thickness of 1.0 μm), a solution in which Vylon 200 produced by Toyobo Co. Ltd. was dissolved in methylethyl ketone was coated onto substrate 1 obtained by coating an Al sputtered layer (aluminum layer formed via sputtering) of 70 nm (700 A) on a polyimide film (UPILEX S125, produced by Ube Industries, Ltd.) having a thickness of 125 μm, followed by drying to prepare substrate 1 possessing an undercoat layer.

Further, aging was conducted at 80° C. for 10 days to remove a low molecular component. The low molecular component in this case was 0.001 mg/m².

### (Preparation of Vapor-Phase Deposition Type Stimulable Phosphor Layer as Well as Phosphor Plate)

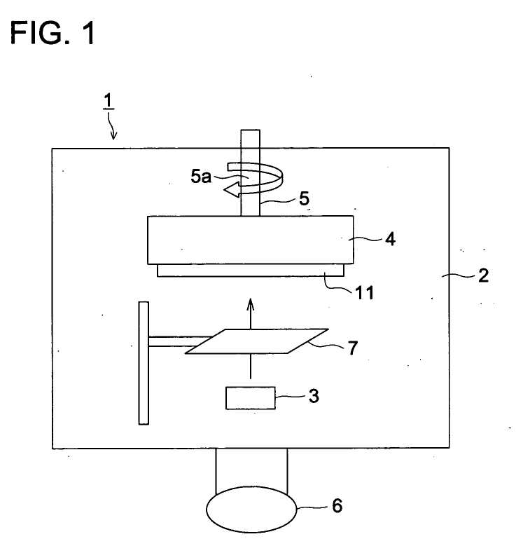

A stimulable phosphor layer containing a stimulable phosphor (CsBr:Eu) was formed on the surface of substrate 1 possessing an undercoat layer, employing a vapor-phase deposition (evaporation) apparatus shown in FIG. 1.

The evaporation was carried out as follows. Substrate 1 was placed in the foregoing vapor-phase deposition apparatus. Subsequently, raw phosphor material (CsBr:Eu) was subjected to press molding, and placed in a water-cooled crucible (unshown) to be placed as an evaporation source.

Subsequently, the inside of the vapor-phase deposition apparatus was evacuated through the exhaust outlet which was connected to a pump, and further, nitrogen was introduced through the gas inlet {at a flow rate of 1,000 sccm (sccm: standard, ml/min(1×10⁻⁶ m³/min)). After maintaining a vacuum degree of 6.65×10⁻² Pa in the apparatus, the vacuum source was heated to 650° C., and evaporation was carried out as follows. An alkali halide phosphor composed of CsBr:0.0001 Eu was deposited onto one surface of substrate 1 from the normal direction to the substrate surface (namely matching the slit and the evaporation source in the normal direction (θ2=nearly 0 degree)), while conveying the substrate in the direction parallel to the substrate. Distance (d) between the substrate and a vaporization source was maintained at 60 cm. When the thickness of the stimulable phosphor layer reached 400 μm, the evaporation was terminated, whereby a vapor-phase deposition type stimulable phosphor layer was prepared to obtain a phosphor plate.

### <Preparation of Protective Film 1>

As a barrier protective film of a phosphor plate, one shown in the following structure (A) was prepared, and designated as protective film 1.

### Structure (A)

Polyethylene Terephthalate (PET) Film 12/Barrier PET Film 12/Sealant Film 40

Polyethylene terephthalate (PET) film:

In this case, solid printing was conducted on the undersurface of the PET film employing cyan ink to set transmittance at 690 nm to 75%.

Barrier PET Film:

A biaxially oriented PET film having a thickness of 6 μm as a substrate was arranged to be placed in an electron beam heating system vacuum evaporator, and an aluminum oxide layer having a thickness of 15 nm was evaporated on one surface of the PET film to obtain the 1^{st} evaporation layer.

Subsequently, the following coating solution was prepared.

(Liquid 1)

| | |
|---|---|
| Tetraethoxysilane | 10.4 g |
| Hydrochloric acid (0.1 mol/LN) | 89.6 g |

(Liquid 2)

| | |
|---|---|
| Polyvinyl alcohol | 3.0 g |
| Water | 87.3 g |
| Isopropyl alcohol | 9.7 g |

The above-described Liquid 1 and Liquid 2 were mixed at a ratio of 6:4 to obtain a coating solution. The resulting coating solution was coated by a gravure method, followed by drying at 120° C. for one minute, whereby a 0.5 μm thick 1^{st} evaporation layer and a first gas barrier coating layer were formed.

Thereafter, the substrate, on which the 1^{st} evaporation layer and the 1^{st} gas barrier coating layer were formed, was placed in a vacuum evaporator fitted with an electron beam heating system, and 15 nm thick aluminum oxide was evaporated, whereby a 2^{nd} evaporation layer was prepared. Further, a 2^{nd} gas barrier coating layer was prepared on the 2^{nd} evaporation layer in the same manner as the 1^{st} gas barrier coating layer. Two barrier films as described above were prepared. BXX5134 (produced by Toyo Ink Production Co., Ltd.) was added into acrylic adhesive material BPS5215 (also produced by Toyo Ink Production Co., Ltd.), and the resulting mixture was coated onto the 2^{nd} gas barrier coating layer surface of one of the films so as to give a dry thickness of 5 μm to obtain an adhesive layer via hot-air drying. The surface of the 2^{nd} gas barrier coating layer of the other barrier film was overlapped on the resulting adhesive layer followed by pressure contact to obtain a transparent barrier PET film.

### Sealant Film:

CPP (casting polypropylene) was employed as a sealant film.

The numeral after each of the resin films indicates its thickness (μm)).

The above-described “/” means that in the case of a dry lamination adhesive layer, an adhesive agent layer has a thickness of 2.5 μm. The employed adhesive agent for dry lamination was a two liquid reaction type urethane based adhesive agent.

In addition, as described above, water vapor permeability of the protective layer was measured in accordance with JIS K7129B (at 40° C. and 90% RH).

### <<Sealing of Phosphor Plate, and Preparation of Radiation Image Conversion Panel 1>>

A sealing envelop was prepared in such a manner that protective film 1 was folded in two, and three sides were thermally sealed. Subsequently a phosphor plate was placed in the resulting bag for sealing and the periphery was subjected to fusing under reduced pressure, employing an impulse sealer, whereby radiation image conversion panel 1 was prepared.

As to the phosphor plate, a sealant layer of the protective film and so forth, the low molecular component was identified, and quantity of the low molecular component was also determined.

### <<Preparation of Radiation Image Conversion Panel 2>>

Radiation image conversion panel 2 was prepared similarly to preparation of radiation image conversion panel 1, except that protective film 1 was replaced by the following protective film 2.

### <Preparation of Protective Film 2>

Protective film 2 was prepared similarly to preparation of protective film 1, except that two barrier layers (barrier PET film) in protective film 1 were attached to each other, and the foregoing structure was replaced by polyethylene terephthalate (PET) film 12/barrier PET film 12/barrier PET film 12/sealant film 40.

### <<Preparation of Radiation Image Conversion Panel 3>>

Radiation image conversion panel 3 was prepared similarly to preparation of radiation image conversion panel 1, except that after providing a phosphor layer, a polyparaxylene layer was provided thereon via the following method of evaporation.

### <Evaporation of Polyparaxylene Layer>

Di-p-xylene was vapor-deposited on a phosphor layer employing a PDS2010 type (produced by Japan Parylene Japan Co., Ltd. to form a polyparaxylene layer. An vapor-deposition thickness of 2 μm was obtained. After vapor deposition, drying was conducted at a reduced pressure degree of 4500 Pa at 30° C. to remove the low molecular component.

### <<Preparation of Radiation Image Conversion Panel 4>>

Radiation image conversion panel 4 was prepared similarly to preparation of radiation image conversion panel 1, except that substrate 1 was replaced by the following substrate 2.

### <Preparation of Substrate 2>

Vylon 200 produced by Toyobo Co., Ltd. dissolved in methylethyl ketone was coated onto substrate 2 obtained by coating an Al sputtered layer on a polyethylene naphthalate film (Polynex Q51, produced by Teijin DuPont Films Japan Ltd., so as to give a thickness of 70 nm (700 A), followed by drying to form an undercoat layer having a dry thickness of 1.0 μm, whereby substrate 2 possessing an undercoat layer was prepared. Further, aging was conducted at 45° C. for 2 days to remove the low molecular component. The resulting amount of the residual low molecular component in this case is shown in Table 1.

### <<Preparation of Radiation Image Conversion Panel 5>>

Radiation image conversion panel 5 was prepared similarly to preparation of radiation image conversion panel 2, except that substrate 1 subjected to aging at 80° C. for 10 hours was replaced by substrate 1 subjected to aging at 80° C. for 5 hours.

### <<Preparation of Radiation Image Conversion Panel 6>>

Radiation image conversion panel 6 was prepared similarly to preparation of radiation image conversion panel 1, except that protective film 1 was replaced by the following protective film 3.

### <Preparation of Protective Film 3>

Protective film 3 was prepared similarly to preparation of protective film 1, except that three barrier layers (barrier PET film) in protective film 1 were attached to each other, and the foregoing structure was replaced by polyethylene terephthalate (PET) film 12/barrier PET film 12/barrier PET film 12/barrier PET film 12/sealant film 40.

### <<Preparation of Radiation Image Conversion Panel 7>>

Radiation image conversion panel 7 was prepared similarly to preparation of radiation image conversion panel 1, except that substrate 1 was replaced by the following substrate 3.

Substrate 3 possessing a undercoat layer was prepared similarly to preparation of substrate 1, except that the substrate is not subjected to aging.

### <<Preparation of Radiation Image Conversion Panel 8>>

Radiation image conversion panel 8 was prepared similarly to preparation of radiation image conversion panel 1, except that protective film 1 was replaced by the following protective film 4.

### <Preparation of Protective Film 4>

Protective film 4 was prepared similarly to preparation of protective film 1, except that the barrier PET film was replaced by a film in which 12 μm thick alumina was layered on a PET film having a thickness of 12 μm via vacuum evaporation, as a barrier layer.

### <<Preparation of Radiation Image Conversion Panel 9>>

Radiation image conversion panel 9 was prepared similarly to preparation of radiation image conversion panel 1, except that no undercoat layer is provided.

### <<Preparation of Radiation Image Conversion Panel 10>>

Radiation image conversion panel 10 was prepared similarly to preparation of radiation image conversion panel 1, except that the substrate was replaced by the following substrate 4.

### (Preparation of Substrate 4)

Crystallized glass (FIRELITE, produced by Nippon Electric Glass Co., Ltd.) was employed as substrate 4, vylon 200 (produced by Toyobo Co. Ltd) dissolved in methylethyl ketone was coated thereon, followed by drying to form an undercoat layer having a dry thickness of 1.0 μm, whereby a substrate possessing the undercoat layer was prepared.

Further, aging was conducted at 80° C. for 10 days to remove the low molecular component, whereby substrate 4 possessing an undercoat layer (in this case, the undercoat layer had a residual low molecular component amount of 0.001 mg/m₂).

Radiation image conversion panels 1-10 were prepared as described above.

### <<Evaluation of Radiation Image Conversion Panel>>

The following evaluations were made employing radiation image conversion panels 1-10 prepared above.

### <<Evaluation of Luminance>>

Each of the radiation image conversion panels was exposed to X-rays at a tube voltage of 80 kVp through a chart made of lead. Thereafter, the radiation image conversion panel was stimulated utilizing. He—Ne laser light (having a wavelength of 633 nm). Stimulated luminescence radiated from the phosphor layer was received with a light receiving device (a photomultiplier with spectral sensitivity-S-5) and converted into electric signals, which were subjected to analog/digital conversion. Converted signals were recorded on a hard disk, and the X-ray image recorded on the hard disk was examined and recorded via analysis of the recorded data with a computer. The signal values of 100×100 pixels in the middle of the image were averaged out to obtain the initial luminescence value.

### <<Luminance Moisture Resistance>>

The radiation image conversion panel sample, of which the above-described emission amount (initial luminescence value) was confirmed, was placed in a constant temperature and humidity oven at 35° C. and 85% RH, and the emission amount after storage for a predetermined duration (shown in Table 2) was measured to evaluate the luminance moisture resistance. When the emission amount at the initial stage prior to placing each of the panels in the constant temperature and humidity oven was set to 1.0, the signal value after placing each of the panels in the constant temperature and humidity oven, as a relative value, was shown in Table 2.

Results are shown in Table 2.

TABLE 1
Radiation image conversion panel

| | | | | | | | | | | Protective film | |
|---|---|---|---|---|---|---|---|---|---|---|---|
| | | | | | | | | | | | Gas barrier |
| | | | | | Lower layer of | | | | | | degree |
| | | | | | phosphor layer | | | Upper layer of | | | Water vapor |
| | Substrate | | | | (Undercoat layer) | | | phosphor layer | | | permeability |
| No. | No. | Kinds | Aging | *1 | Kinds | Aging | *1 | Kinds | *1 | No. | (g/m² · 24 h) |
| 1 | 1 | PI | *2 | 0.001 | Vylon 200 | *2 | 0.009 | None | — | 1 | 0.1 (Inv.) |
| 2 | 1 | PI | *2 | 0.001 | Vylon 200 | *2 | 0.009 | None | — | 2 | 0.009 (Inv.) |
| 3 | 1 | PI | *2 | 0.001 | Vylon 200 | *2 | 0.009 | Polyparaxylene | 34 | 1 | 0.1 (Inv.) |
| | | | | | | | | layer | | | |
| 4 | 2 | PEN | At 45° C. | 0.01 | Vylon 200 | At 45° C. | 149.99 | None | — | 2 | 0.1 (Inv.) |
| | | | for 2 days | | | for 2 days | | | | | |
| 5 | 1 | PI | At 80° C. | 0.01 | Vylon 200 | At 80° C. | 399.99 | None | — | 2 | 0.009 (Inv.) |
| | | | for 5 | | | for 5 hours | | | | | |
| | | | hours | | | | | | | | |
| 6 | 1 | PI | *2 | 0.001 | Vylon 200 | *2 | 0.009 | None | — | 3 | 0.005 (Inv.) |
| 7 | 3 | PI | None | 0.03 | Vylon 200 | None | 699.97 | None | — | 1 | 0.1 (Inv.) |
| 8 | 1 | PI | *2 | 0.001 | Vylon 200 | *2 | 0.009 | None | — | 4 | 1.5 (Comp.) |
| 9 | 1 | PI | *2 | 0.001 | None | *2 | 0 | None | — | 1 | 0.1 (P Inv.) |
| 10 | 4 | Glass | *2 | 0 | Vylon 200 | *2 | 0.001 | None | — | 1 | 0.1 (Inv.) |

*1: Residual molecular component (mg/m²),
*2: At 80° C. for 10 days
Inv.: Present invention,
Comp.: Comparative example

TABLE 2

| | Evaluated results | | | | | |
|---|---|---|---|---|---|---|
| Radiation | Luminance moisture resistance | | | | | |
| image | (storage at 35° C. and 85% RH) | | | | | |
| conversion | | After | After | After | After | |
| panel | Initial | 30 | 50 | 100 | 300 | |
| No. | stage | days | days | days | days | Remarks |
| 1 | 1 | 1 | 1 | 0.97 | 0.94 | Present |
| | | | | | | invention |
| 2 | 1 | 1 | 1 | 1 | 0.97 | Present |
| | | | | | | invention |
| 3 | 1 | 1 | 1 | 0.95 | 0.93 | Present |
| | | | | | | invention |
| 4 | 1 | 1 | 1 | 0.93 | 0.92 | Present |
| | | | | | | invention |
| 5 | 1 | 1 | 1 | 0.90 | 0.89 | Present |
| | | | | | | invention |
| 6 | 1 | 1 | 1 | 1 | 0.98 | Present |
| | | | | | | invention |
| 7 | 1 | 1 | 0.9 | 0.7 | 0.6 | Comparative |
| | | | | | | example |
| 8 | 1 | 1 | 0.7 | 0.6 | 0.3 | Comparative |
| | | | | | | example |
| 9 | 1 | 1 | 1 | 0.98 | 0.95 | Present |
| | | | | | | invention |
| 10 | 1 | 1 | 1 | 0.99 | 0.96 | Present |
| | | | | | | invention |

PI: Polyimide film (UPILEX S125, produced by Ube Industries, Ltd.) having a thickness of 125 μm
PEN: Polyethylene naphthalate film (Polynex Q51, produced by Teijin DuPont Films Japan Ltd.)
Glass: FIRELITE, produced by Nippon Electric Glass Co., Ltd. having a thickness of 5 mm.

As is clear from Table 1 and Table 2, it is to be understood that the radiation image conversion panels of the present invention exhibit excellent luminance moisture resistance (durability during storage specifically at high temperature and high humidity) in comparison to those of the comparative example.

It is confirmed in the present invention that provided can be each of the radiation image conversion panels fitted with a stimulable phosphor prepared via vapor deposition exhibiting excellent luminance moisture resistance (durability during storage specifically at high temperature and high humidity).

1. A radiation image conversion panel comprising a phosphor plate and a gas barrier protective film entirely covering the phosphor plate, the phosphor plate comprising a substrate and provided thereon, a stimulable phosphor layer formed via a vapor deposition method,
wherein a polymer layer is provided on at least one of the substrate and the stimulable phosphor layer;
the polymer layer has a low molecular component amount of 0.00001-500 mg/m²; and
the protective film has a water vapor permeability of 0.0001-1.0 g/m²·24 h.

2. The radiation image conversion panel of claim 1,
wherein the substrate comprises an organic polymer;
a total amount of a 1^{st} low molecular component contained in the substrate and a 2^{nd} low molecular component contained in the polymer layer is 0.00001-500 mg/m²; and
the protective film has a water vapor permeability of 0.0001-1.0 g/m²·24 h.

3. A radiation image conversion panel comprising a phosphor plate and a gas barrier protective film entirely covering the phosphor plate, the phosphor plate comprising a substrate and provided thereon, a stimulable phosphor layer formed via a vapor deposition method,
wherein the substrate comprises an organic polymer;
the substrate has a low molecular component amount of 0.00001-500 mg/m²; and
the protective film has a water vapor permeability of 0.0001-1.0 g/m²·24 h.
